(19) United States
(12) Patent Application Publication
(10) Pub. No.: US 2008/0083146 A1
(43) Pub. Date: Apr. 10, 2008

(54) Unfolding Advertising Support Retained by Magnetic Means

(75) Inventor: Raul Santiago Martin Presa, Arganda Del Rey Madrid (ES)

Correspondence Address: BANNER & WITCOFF, LTD., 1100 13th STREET, N.W., SUITE 1200, WASHINGTON, DC, 20005-4051, US

(73) Assignee: SERIGRAFIA MARGI, S.L., Arganda Del Rey Madrid (ES)

(21) Appl. No.: 11/556,476

(22) Filed: Nov. 3, 2006

(30) Foreign Application Priority Data
Oct. 5, 2006 (EP) 06381038.6

(51) Int. Cl. G09F 7/04

(52) U.S. Cl. 40/600

(57) ABSTRACT

Advertising support formed of at least one body, each of said bodies consisting of an advertising sheet and an inner unfolding and retaining framework, where the advertising sheet is a single sheet joined at its ends to form an interior infold, having another interior infold done in the middle of the sheet, both infolds facing each other and acting as a support along their whole length for inner sheets, which have superimposed overlaps where magnetic means are disposed for the unfolding and retention of the advertising support, in such a way that on one of the overlaps there is a single magnetic means, whilst on the other of the overlaps there is an alignment of supplementary magnetic means, so that the selection of one or the other permits adjustment of the degree of convexity that we wish to give the advertising support when unfolded.

### OBJECT OF THE INVENTION

The object of the present invention is an unfolding advertising support which is held in its unfolded position by way of magnetic means.

The support that is the object of the invention is made up of die-stamped and cut inner cardboard sheets or wings, duly fixed to an advertising sheet carrying the information to be shown. The support has the special feature of being able to remain folded, while, once the inner wings are brought together and retained, the advertising area adopts an external surface forming an elliptical-section support surface.

The support is also characterised by the fact of having the special feature of its automatic unfolding and retaining through the action of magnetic retention means disposed on the inner wings of the unfolding assembly. Furthermore, as the advertising support is provided with magnetic retaining means, folding is carried out quickly and easily, with the least intervention possible, being among the simplest of the unfolding advertising supports to fold.

Besides assisting in the automatic unfolding and acting as a means for retaining the support when unfolded, thanks to the configuration that they present, the magnetic means allow us to adjust the degree of convexity that we may wish to apply to the advertising surface.

The automatic unfolding support that is the object of the invention enables it to be adapted not only for ellipsoidal, but also quadrangular or triangular advertising units, which renders it especially versatile.

The present invention, therefore, lies within the area of unfolding advertising supports and, in particular, amongst those that are provided with magnetic means for retaining and adjusting the degree of unfolding.

### BACKGROUND OF THE INVENTION

Hitherto there have been many unfolding advertising supports that are provided with elastic means to assist their unfolding, such as the support that is shown in patent Wo 2002095719.

These elastic means used for the unfolding of advertising supports require elastic means for unfolding purposes to be disposed on the inner wings or framework. These elastic means remain elongated when the support is folded, so that when the unfolding starts the tractive force of the elastic means causes the advertising unit to unfold.

In general, these advertising supports using elastic means as the means that permit their unfolding have a number of drawbacks: on the one hand, when the assembly is folded back it requires the elastic means to be tensioned, on the other, the elastic means used for its correct unfolding must have certain dimensions, and what is more the elastic means have to be replaced every so often.

In addition, the elastic means used in the unfolding of the advertising supports unfold the advertising support in a fixed way, i.e. the degree of convexity of the advertising surface area is always the same and it cannot be adjusted.

It is therefore an object of the present invention to develop an advertising support that overcomes the previous drawbacks, using as the folding means ones that are different from the elastic means used hitherto, being replaced by others that enable the degree of convexity of the advertising surface to be adjusted, that do not require regular replacement, and that are not subject to their degree of elasticity.

All the foregoing disadvantages are overcome with the advertising support retained by magnetic means, as the one that is proposed in the present invention.

### DESCRIPTION OF THE INVENTION

The present invention of an unfolding advertising support retained by magnetic means basically consists of die-stamped and cut sheets of cardboard, which, when duly mounted and stuck on an advertising sheet, permit by means of a slight deformation the unfolding and subsequent retention of the totem or advertising assembly automatically, thanks to the disposition of magnetic means with which the advertising support is provided.

The sheet used as the advertising sheet has the special feature of being formed as a single sheet, having certain terminal sections of its ends joined together, as well as an internal infold done exactly in the middle.

Both infolds, the one at the terminal sections of the ends and the one done in the middle, form vertical sections supporting the inner sheets or wings.

Each of the inner sheets presents a given geometry, so that when the advertising support is unfolded they are superimposed over a sufficient section. On one of the sheets there is a recessed magnet, while the other is provided with a series of magnets aligned and oriented so that the magnetic flows are closed with the permanent magnet of the opposing overlap when in proximity.

The disposition of a series of permanent magnets in alignment on one of the inner sheets on the overlap overlaying the other sheet enables one of the magnets to be selected, so that it is possible to adjust the degree of convexity presented by the outer advertising surface, depending on such different determining factors as, for instance, space and appearance.

The inner sheets may also be provided with dies, such that they will permit their insertion and connection by using elastic means to assist the unfolding, although they are merely an additional discretional option and are not necessary in any case.

The disposition of the elastic means could be anywhere on the inner sheets, wherever it is most appropriate.

Thanks to the fact that the retaining means are magnetic, the folding of the assembly is achieved in the simplest way possible with the minimum human intervention, so that of all the unfolding supports this is the advertising support that is easiest to fold.

### DESCRIPTION OF THE DRAWINGS

To supplement the description that is being given and in order to assist in a clearer understanding of the features of the invention, a set of drawings is adjoined hereto, wherein the most significant details of the invention are represented for purely informative and non-restrictive purposes.

FIG. 1 shows in simplified form an advertising totem consisting of two bodies, where only on one of the bodies composing it we have represented the inner sheets that form it and enable it to be unfolded and retained.

FIG. 2 shows in simplified form the process of approximation of the inner sheets in order to bring about the unfolding of the advertising support.

### PREFERRED EMBODIMENT OF THE INVENTION

In the light of the figures we now go on to describe a mode of preferred embodiment of the invention proposed.

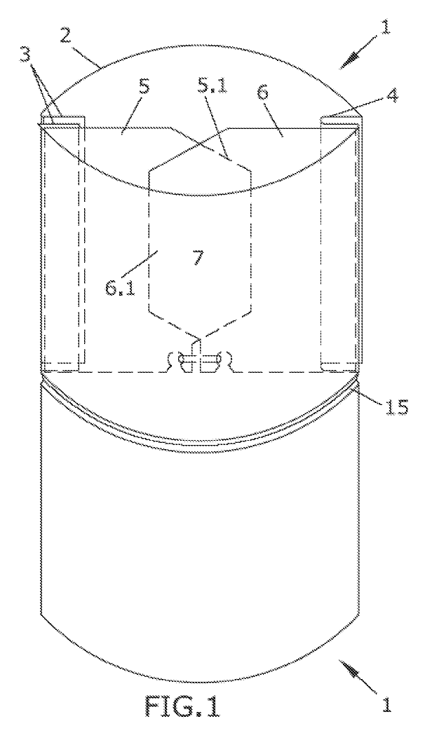

In FIG. 1, we observe a totem or unfolded advertising unit which is made up of two bodies (1) joined by a line of folding (15). There may be any number of bodies (1) forming the advertising support although naturally there has to be at least one body (1).

The advertising support unit formed by at least one body (1) is made up of a single outer sheet on which the advertising to be displayed is disposed and it is closed on itself, i.e. joined at its free ends.

In FIG. 1, we observe that the advertising sheet (2) has the final sections of its ends joined forming an infold (3); furthermore, at the mid-way point in the length of the advertising sheet (2) there is another infold (4) done.

Both infolds (3) and (4) face each other irrespective of how the unit is situated, whether folded or unfolded, and they act as a means of support for the inner sheets (5) and (6) used for the mounting and unfolding of the advertising support.

Each one of the inner sheets (5) and (6) presents respectively overlaps (5.1) and (6.1), which, when the unit is unfolded, are superimposed defining an area of overlay (7).

Moreover, at its end opposite to that of the overlaps (5.1) and (6.1), each of the sheets (5) and (6) is attached to the internal infolds (3) and (4), respectively, over the whole length on each of the bodies (1) forming the advertising support.

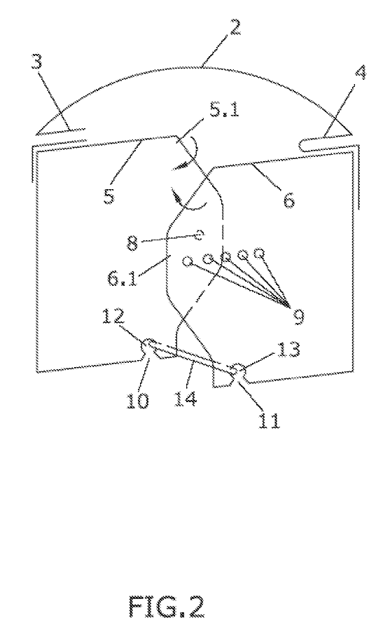

FIG. 2 shows how on one of the inner sheets (5), at its overlap (5.1) a permanent magnet (8) is disposed in recessed form, whilst a series of permanent magnets (9) are disposed in alignment on the other of the inner sheets (6), at their overlap (6.1).

The magnets may be recessed or stuck with adhesives, and whatsoever combinations we wish may be made with regard to their location and how they are set in place, without this altering the essential nature of the invention.

The orientation of the permanent magnets (8) and (9) should be such that it will permit the closure of the magnetic flows, i.e. with their opposite poles confronted.

Thanks to the presence of a plurality of aligned permanent magnets (9) on one of the overlaps of the inner sheets, it is possible to select with which of them we wish to secure the other magnet. The choice of one or the other will modify the degree of convexity that the advertising sheet (2) will present and the most suitable adjustment may be made according to the factors determining the advertising display.

Lastly, we should mention that, as we pointed out above, and merely as an additional optional means of reinforcement, the advertising support could be provided with elastic means (14), which would be attached to each of the inner sheets (5) and (6), each of the sheets presenting for this purpose, on at least one of their edges, notches (10) and (11) connecting up with perforations (12) and (13), where the ends of the advertising means may be housed.

The essential nature of this invention is not altered by variations in materials, form, size and layout of the component elements, described in a non-restrictive way but merely sufficing for it to be reproduced by an expert.

1. Unfolding advertising support retained by magnetic means in an unfolded position, formed by at least one body (1), where each body is joined to the next one by means of a line of folding (15), and it is made up of an advertising sheet (2) and an inner framework, characterised in that the means used for the unfolding and retention are magnetic means disposed on the inner framework.

2. Advertising support, according to claim one, characterised in that the advertising sheet (2) is a closed sheet (2) which has the terminal sections of its ends joined forming an internal infold (3); furthermore, at a mid-way point in the length of the advertising sheet (2) there is another infold (4) done, such that they are facing and act as a means of support along their whole length for inner sheets (5) and (6) used for the mounting and unfolding of the advertising support on which the magnetic unfolding and retention means are disposed.

3. Advertising support, according to claim two, characterised in that each of the inner sheets (5) and (6) present, respectively, overlaps (5.1) and (6.1), which are superimposed defining an area of overlay (7) when the unit is unfolded.

4. Advertising support, according to claim three, characterised in that a permanent magnet (8) is disposed on one of the inner sheets (5) or (6), at their respective overlap (5.1) or (6.1), while a series of permanent magnets (9) is disposed in alignment on the other of the inner sheets (5) or (6), at its overlap (5.1) or (6.1).

5. Advertising support, according to claim one, characterised in that the permanent magnets are recess-mounted on one of the overlaps or on both, whilst they are attached with adhesives in the event of their not being recessed.

6. Advertising support, according to the preceding claims, characterised in that, in addition to the magnetic unfolding and retaining means, elastic means attached to the inner sheets (5) and (6) are used, each of the sheets presenting for this purpose, at one of its edges at least, notches (10) and (11) that join up with perforations (12) and (13), where the ends of the advertising means are housed.
